(19) United States
(12) Patent Application Publication
(10) Pub. No.: US 2026/0072052 A1
(43) Pub. Date: Mar. 12, 2026

(54) Buffer Dilution System That Provides More Accurate Inline Measurements

(71) Applicant: Asahi Kasei Bioprocess America, Inc., Glenview, IL (US)

(72) Inventors: Cory Hinz, Glenview, IL (US); Nainesh Shah, Glenview, IL (US)

(21) Appl. No.: 19/325,605

(22) Filed: Sep. 11, 2025

Related U.S. Application Data
(60) Provisional application No. 63/693,577, filed on Sep. 11, 2024.

(51) Int. Cl. G01N 35/10

(52) U.S. Cl. CPC G01N 35/1016; G01N 35/1002; G01N 2035/1032; G01N 2035/1058

(57) ABSTRACT

An inline buffer dilution system is provided that includes a first flow controller fluidly connected to a supply of a first buffer, a second flow controller fluidly connected to a supply of a second buffer, and a first mixer fluidly connected to the first and second flow controllers and configured to mix an amount of the first buffer and the second buffer to produce a buffer solution. Characteristics of this solution are measured through a series of sensors before the buffer solution is diluted in a mixer, in which a third flow controller fluidly connected to a supply of diluent is fluidly connected to the mixer. The system further includes a central controller configured to control the release of the diluent liquid, the first buffer, and the second buffer being mixed in the first mixer, such that diluted buffer solution meets certain target characteristics.

### CROSS-REFERENCE TO RELATED APPLICATION

The present application claims the priority benefit of U.S. Provisional Application No. 63/693,577, titled “Buffer Dilution System that Provides More Accurate Inline Measurements,” and filed Sep. 11, 2024, the entire content of which is hereby incorporated by reference in its entirety.

### FIELD

The present disclosure generally relates to inline buffer dilution systems and, more particularly, to an inline buffer dilution system providing more accurate inline measurements.

### BACKGROUND

It is common to mix two or more liquids together in order to yield a desired concentration or other characteristics (e.g., pH, conductivity, optical density, refractive index, etc.) of the constituent liquids in the produced mixture. Indeed, this mixing, which may be referred to as blending, is fundamental to many industrial segments. As an example, blending systems are used to create blended liquids that are provided to chromatography columns in order to permit the separation of mixtures for analysis or purification.

### SUMMARY

In accordance with a first aspect of the present disclosure, an inline buffer dilution system is provided. The inline buffer dilution system includes a first flow controller adapted to communicate with a vessel comprising a supply of a first buffer, a second flow controller adapted to communicate with a vessel comprising a supply of a second buffer, and a first mixer fluidly connected to the first and second flow control mechanism and configured to receive an amount of first buffer fluid via the first flow controller and second buffer fluid via the second flow controller, the first mixer further configured to mix the amount of the first buffer fluid and the second buffer fluid to produce a buffer solution. The inline buffer dilution system also includes a series of sensors fluidly connected to the first mixer and configured to receive the buffer solution from the first mixer, the sensors configured to measure characteristics of the buffer solution, a third flow controller adapted to communicate with a vessel comprising a supply of a diluent fluid, the third flow controller being arranged downstream of the series of sensors, and a second mixer fluidly connected to the series of sensors and the third flow controller, the second mixer configured to receive the buffer solution via the series of sensors and an amount of diluent fluid via the third flow controller, the second mixer further configured to mix the buffer solution and the amount of diluent fluid to produce a diluted buffer solution. The inline buffer dilution system further includes a central controller communicatively connected to the series of sensors and the first, second, and third flow controllers, the central controller configured to control the flows of the first buffer through the first flow controller, the second buffer through the second flow controller, and the diluent liquid through the third flow controller.

### BRIEF DESCRIPTION OF THE DRAWINGS

FIG. 1 is a schematic illustration of a known inline buffer dilution system;

FIG. 2 is a schematic illustration of an inline buffer dilution system constructed in accordance with the teachings of the present disclosure; and

FIG. 3 is a table depicting pH measurements for six different formulations and the improvement in accuracy of pH measurements with the implementation of the inline buffer dilution system constructed in accordance with the teachings of the present disclosure.

### DETAILED DESCRIPTION

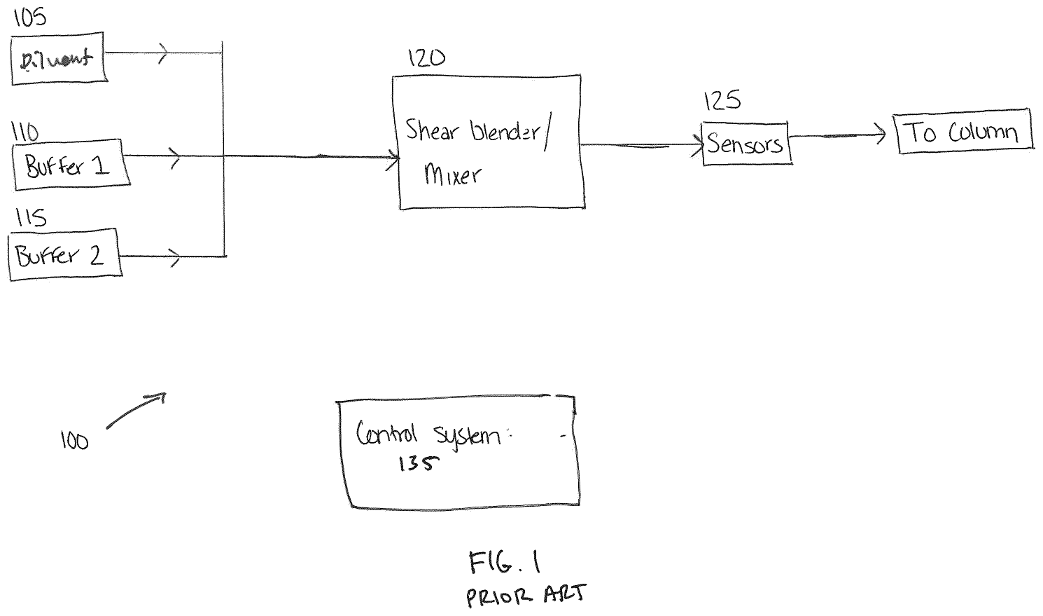

FIG. 1 illustrates an example of a known inline buffer dilution system 100. The inline buffer dilution system 100 is generally configured to mix two or more liquids in a manner that yields a diluted solution having one or more desired characteristics (e.g., a desired concentration of the ingredients, a desired pH, a desired conductivity, a desired temperature, a desired optical density, a desired refractive index, etc.). At the same time, the inline buffer dilution system 100 is configured to yield a minimum mixing threshold across a range of fluid flows, such that the inline buffer dilution system 100 is scalable depending on the given application. To these ends, the inline buffer dilution system 100 generally includes a first buffer 110 (e.g., a conjugate acid/base or salt), a second buffer 115 (e.g., a conjugate base/acid or salt), a diluent 105 such as water, and a mixer 120 that mixes the first buffer 110, the second buffer 115, and the diluent 105 before the flow characteristics of the mixed solution are measured by a series of inline sensors 125. The inline buffer dilution system 100 can also include various pumps for the diluent 105 and the first and second buffers 110, 115 as well as a control system 135 that is communicatively connected to the pumps, the mixer 120, and the sensors 125 to control the operation of the inline buffer dilution system 100. Experiments conducted by the inventors of the present disclosure have shown, however, that the inline placement of particular sensors, such as the pH sensor, has led to inaccurate sensor measurements and an inaccurately diluted buffer solution. This is particularly evident when very low concentrations of the first buffer 110 and/or the second buffer 115 are part of the diluted buffer solution, which the inventors theorize stems from the fact that the low concentrations of the first buffer 110 and/or the second buffer 115 within the diluted buffer solution degrade or slowdown the ability of the pH sensor (and other sensors) to accurately detect the pH and other characteristics of the diluted buffer solution.

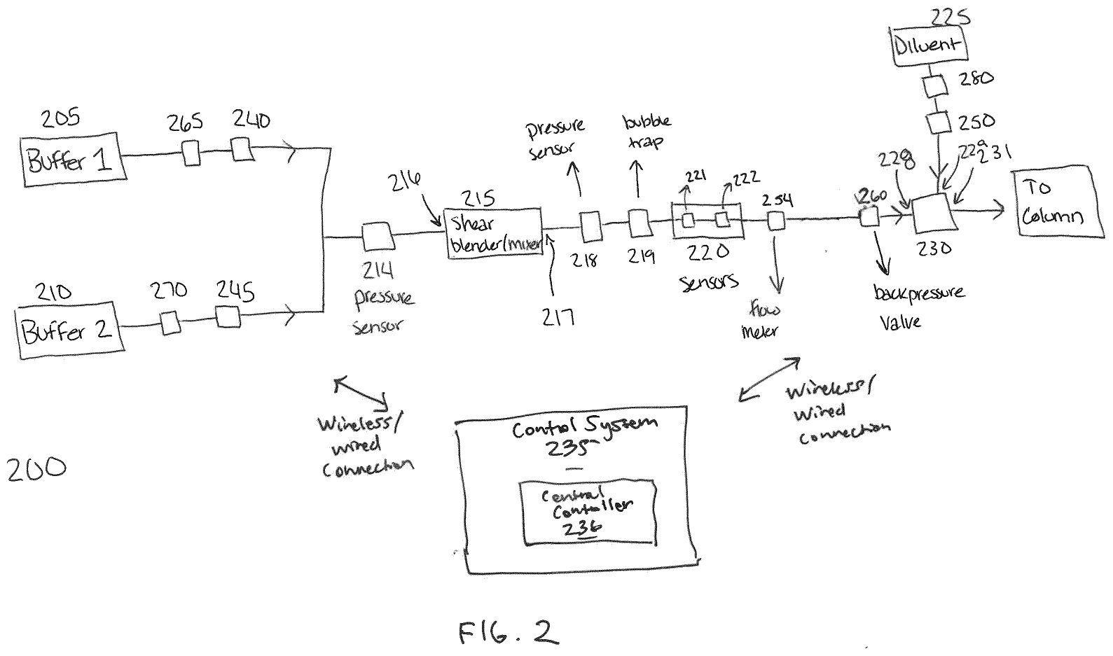

FIG. 2 illustrates an example of an inline buffer dilution system 200 that is constructed in accordance with the current disclosure and aims to address the accuracy issues associated with the inline buffer dilution system 100. Like the inline buffer dilution system 100, the inline buffer dilution system 200 is generally configured to mix two or more liquids in a manner that yields a diluted solution having one or more desired (or target) characteristics (e.g., a desired concentration of the constituents in the mixture, a desired pH, a desired conductivity, a desired optical density, a desired refractive index, etc.). However, the inline buffer dilution system 200 is configured so that the sensors in the inline buffer dilution system 200 more accurately measure the characteristics of the diluted buffer solution (as compared to the sensors 125 of the inline buffer dilution system 100), particularly the pH of the diluted solution flowing therethrough. It was expected, based on convention and knowledge in the field, that the solution to the accuracy/spontaneous accurate reading problem described above in connection with the known inline buffer dilution system 100 would be to incrementally add buffer(s) to a larger volume of diluent until the concentration of the buffer(s) reaches a minimum threshold for an accurate pH reading. Unexpectedly, however, the inventors for the present application found that measuring the pH of a small(er) quantity of high(er) concentration buffer(s), prior to the addition of diluent, results in a more accurate measurement. Thus, the inline buffer dilution system 200 is configured to measure the pH of the buffer solution before dilution, where the concentration of the buffer(s) is higher than the concentration of the buffer(s) after dilution.

As illustrated in FIG. 2, the inline buffer dilution system 200 generally includes a first flow controller 240 and a second flow controller 245. The first flow controller 240, which in this example takes the form of a proportional controller, is adapted to fluidly communicate with a first vessel 205 containing and controlling supply of a first buffer (e.g., comprising an acid, a conjugate acid, a phosphate, a salt, a pH tempering, an alcohol, an organic, a nutrient, etc.). As used herein, the term “buffer” refers to an aqueous solution comprising an acid and its conjugate base or a base and its conjugate acid, that resists changes in the pH of that solution (i.e., the buffer exhibits “buffering activity”). A buffer conventionally comprises various additional components besides the acid and its conjugate base or the base and its conjugate acid, such as various salts (e.g., sodium chloride, potassium chloride, and the like), organic compounds (e.g., ethylenediaminetetraacetic acid (EDTA), glycerol, dyes), and the like. A person of skill can select appropriate additional components for a buffer based on its intended application. The second flow controller 245, which in this example also takes the form of a proportional controller, is adapted to fluidly communicate with a second vessel 210 containing and controlling supply of a second buffer that is different from the first buffer (e.g., comprising a base, a conjugate base, a phosphate, a salt, a pH tempering, an alcohol, an organic, a nutrient, etc.). It will be appreciated that the first vessel 205 and/or the second vessel 210 can, but need not, be part of the inline buffer dilution system 200. It will also be appreciated that the inline buffer dilution system 200 can include additional flow controllers and/or flow control valves that are in turn adapted to fluidly communicate with additional vessels for buffers supply.

As illustrated in FIG. 2, the inline buffer dilution system 200 also includes a first flowmeter 265 and a second flowmeter 270. In this example, the first flowmeter 265 is arranged between the first vessel 205 of the first buffer solution and the first flow controller 240, such that the first flowmeter 265 collects data indicative of the amount of the first buffer flowing through the first flow controller 240 (and downstream through the rest of the inline buffer dilution system 200). Alternatively, however, the first flowmeter 265 can be positioned after (i.e., downstream of), or fully integrated with, the first flow controller 240. In this example, the second flowmeter 270 is arranged between the second vessel 210 of the second buffer and the second flow controller 245, such that the second flowmeter 270 collects data indicative of the amount of the second buffer flowing through the second flow controller 245 (and downstream through the rest of the inline buffer dilution system 200). In other examples, however, the second flowmeter 270 can be positioned after (i.e., downstream of), or fully integrated with, the second flow controller 245.

As also illustrated in FIG. 2, the inline buffer dilution system 200 also includes a first mixer 215 and a control system 235. The first mixer 215 is arranged downstream of and fluidly connected to the first and second flow controllers 240, 245. The first mixer 215 preferably takes the form of a shear blender, which the inventors of the present application found helps promote uniform mixing when the first buffer and/or the second buffer is a salt (which tends to be less reactive than other buffers), which in turn yields a more accurate pH measurement. Beneficially, for some formulations, the inventors of the present application found that varying (e.g., increasing) the speed of the shear blender can help further bridge the gap between the measured pH and the actual pH. However, in other examples, the first mixer 215 can take the form of a static mixer or a mixing pump such as the mixing pump 144 described in greater detail in U.S. Pat. No. 11,465,110, the contents of which are hereby incorporated by reference in its entirety. In some examples, the first mixer 215 can be a single-use (or disposable) component, whereas in other examples, the first mixer 215 can be re-used more than once.

The control system 235 includes at least a central controller 236, which in this example is a programmable logic controller that is communicatively connected (via a wired or wireless connection) to the first mixer 215 and the other components of the inline buffer dilution system 200 to control operation of the inline buffer dilution system 200 based on data collected by, for example, the sensors employed in the inline buffer dilution system 200. For example, the central controller 236 uses flow data collected by the first and second flowmeters 265, 270 to control the first and second flow controllers 240, 245 so that the first and second controllers 240, 245 respectively supply a desired amount of the first buffer and the second buffer to the first mixer 215 via an inlet 216 of the first mixer 215. The central controller 236 also causes the first mixer 215 to mix (e.g., by rotation) the supplied first buffer and the supplied second buffer into a buffer solution. For example, the central controller 236 can cause an impeller of the first mixer 215 to rotate, thereby mixing the supplied first buffer and the supplied second buffer into the buffer solution. The buffer solution produced by the mixing is in turn output from the first mixer 215 via an outlet 217 of the first mixer 215.

Besides the first and second flowmeters 265, 270, the inline buffer dilution system 200 also includes a plurality of additional sensors that are also communicatively connected to the control system 235 and provide feedback (e.g., in the form of collected data) to the control system 235 (and operators of the system 200) during operation of the inline buffer dilution system 200 in order to ensure the proper operation of the inline buffer dilution system 200. In this example, as illustrated in FIG. 2, the inline buffer dilution system 200 additionally includes a first pressure sensor 214, a second pressure sensor 218, a conductivity sensor 221, a pH sensor 222, and a third flowmeter 254. In this example, the conductivity sensor 221, the pH sensor 222, and the third flowmeter 254 may form a series of sensors 220 in the system 200 that are located downstream of and fluidly connected to the first mixer 215 to measure characteristics of the buffer solution output from the first mixer 215. In other examples, however, the inline buffer dilution system 200 can include more, less, and/or different sensors (e.g., different property sensors). For example, the inline buffer dilution system 200 need not include the conductivity sensor 221.

The first pressure sensor 214 is arranged between the first and second flow controllers 240 and 245 and the first mixer 215, such that the pressure sensor 214 collects data indicative of the pressure downstream of the first and second flow controllers 240 and 245, and upstream of the first mixer 215. The second pressure sensor 218, meanwhile, is located downstream the first mixer 215, such that the second pressure sensor 218 collects data indicative of the pressure downstream of the first mixer 215. The conductivity sensor 221 is also located downstream of the first mixer 215 and, at least in this example, is located downstream of the second pressure sensor 218. The conductivity sensor 221 collects data indicative of the conductivity of the buffer solution output by the first mixer 215, thereby helping to ensure that the buffer solution has the desired conductivity at the end of the dilution process. In other examples, the conductivity sensor 221 can be positioned elsewhere in the inline buffer dilution system 200.

The pH sensor 222 is likewise positioned downstream of the first mixer 215. In this example, the pH sensor 222 is also positioned downstream of the second pressure sensor 218 and the conductivity sensor 221. In other examples, the pH sensor 222 can be positioned elsewhere in the inline buffer dilution system 200 (e.g., upstream of the conductivity sensor 221). The pH sensor 222 collects data indicative of the pH level of the buffer solution output by the first mixer 215, thereby helping to ensure that the buffer solution has the desired pH. Beneficially, as will be discussed in greater detail below, pH is not altered by changes in volumes for buffer solutions, such that the pH of the buffer solution output by the first mixer 215 will closely track the pH of the eventual diluted buffer solution produced by the inline buffer dilution system 200.

As illustrated in FIG. 2, the inline buffer dilution system 200 also generally includes a third flow controller 250 and a second mixer 230. The third flow controller 250, which in this example takes the form of a proportional flow controller, is adapted to fluidly communicate with a third vessel 225 containing a supply of a diluent (e.g., water, solvent, etc.). It will be appreciated that the third vessel 225 can, but need not, be part of the inline buffer dilution system 200. The inline buffer dilution system 200 also includes a third flowmeter 280 positioned between the third vessel 225 and the third flow controller 250, such that the third flowmeter 280 collects data indicative of the amount of the diluent flowing through the third flow controller 250 (and the second mixer 230). Meanwhile, the second mixer 230 is arranged downstream of and fluidly connected to the third flow controller 250 and the series of sensors 220. So arranged, the second mixer 230 is configured to receive the buffer solution output by the first mixer 215 via a first inlet 228 of the second mixer 230 and the diluent supplied by the third flow controller 250 via a second inlet 229 of the second mixer 230.

The central controller 236 uses flow data collected by the third flowmeter 280 (and other data collected by the sensors of the system 200) to control the third flow controller 250 so that the third flow controller 250 supplies a desired amount of the diluent to the second mixer 230. The central controller 236 in turn causes the second mixer 230 to mix the buffer solution output by the first mixer 215 and the amount of the diluent supplied by the third flow controller 250. In this example, the second mixer 230 takes the form of a static mixer. Examples of static mixing methods include flow division and radial mixing. In any event, the diluted buffer solution produced by the static mixing is in turn output from the second mixer 230 via an outlet 231 of the second mixer 230. The diluted buffer solution output from the second mixer 230 should have the one or more desired characteristics (e.g., the desired pH, the desired conductivity, the desired temperature, the desired density, the desired refractive index). Moreover, since the inline buffer system 200 is arranged to dilute the buffer solution after the pH is measured (at least initially), the pH measurements are more accurate (i.e., closer to the actual pH of the solution) in comparison to a measurement taken after the buffer is diluted. As a result, the control system 235 controls the flow of the buffers from the first and second flow controllers 240, 245 based on more accurate data. The pH of the diluted buffer solution will therefore be near equivalent to the desired pH.

The inline buffer system 200 may optionally include a second series of sensors downstream of the second mixer 230 and configured to receive the diluted buffer solution output from the second mixer 230 and to provide feedback to the central controller 236 about measured characteristics of the diluted buffer solution. The second series of sensors may, for example, include a second pH sensor and a second conductivity sensor. The second conductivity sensor can collect data indicative of the conductivity of the diluted buffer solution output by the second mixer 230, thereby helping to ensure that the diluted buffer solution has the desired conductivity. The second pH sensor can collect data indicative of the pH of the diluted buffer solution output by the second mixer 230, thereby helping to ensure that the diluted buffer solution has the desired pH.

The inline buffer dilution system 200 can optionally further include one or more backpressure control valves controlled by the central controller 236 for promoting mixing within the first mixer 215 and/or the second mixer 230. In the example illustrated in FIG. 2, the inline buffer dilution system 200 includes a backpressure control valve 260 arranged downstream of the first mixer 215 and controlled by the central controller 236. The central controller 236 causes the backpressure control valve 260, which in this example is a pilot driven backpressure regulator, to generate a backpressure that is sensed by the first mixer 215 and, in turn, promotes mixing within the first mixer 215. While the generation of the backpressure reduces the efficiency of the first mixer 215, the usage of the backpressure in this manner effectively creates a recirculation or mixing variable that is adjustable (via the central controller 236) depending on the amount of fluid (in this case, the amount of the first buffer and the second buffer) flowing into and being mixed in the first mixer 215. When, for example, the amount of the fluid flowing into and being mixed in the first mixer 215 is increased, the central controller 236 can increase the recirculation variable by causing the backpressure control valve 260 to increase the generated backpressure, thereby driving further recirculation and ensuring that adequate mixing is performed within the first mixer 215 at this higher flow level. Conversely, when the amount of the fluid flowing into and being mixed in the first mixer 215 is decreased, the central controller 236 can decrease the recirculation variable by causing the backpressure control valve 260 to decrease the generated backpressure, thereby driving less recirculation (as less recirculation is needed at this lower flow level) but still ensuring that adequate mixing is performed within the first mixer 215.

By adjusting the backpressure generated by the backpressure control valve 260 based on the fluid flowing into and being mixed in the first mixer 215, the mixing in the first mixer 215 is effectively normalized across a range of fluid flows. In this example, the mixing in the first mixer 215 is effectively normalized across a range equal to between 2 and 20 liters per minute. In other examples, however, the range of fluid flows may vary. In any case, the first mixer 215 has or yields a minimum mixing threshold across this range of fluid flows. In other words, the first mixer 215 has or yields a minimum mixing threshold at any amount of fluid flow in this range, regardless of how much fluid is flowing into and being mixed in the first mixer 215.

The central controller 236 can control the first flow controller 240 in a manner that creates positive pressure within the first vessel 205 by controlling a pump in fluid communication with the first flow controller 240. In the same manner, the central controller 236 may control the second flow controller 245 in a manner that creates positive pressure within the second vessel 210 by controlling a pump in fluid communication with the first controller 240.

It will be appreciated that some, but not all, characteristics measured by the sensors in the series of sensors 220 will not be equivalent to the desired, corresponding characteristic after the buffer solution from the first mixer 215 is diluted with the diluent via the second mixer 230. As an example, the conductivity of the buffer solution measured by the conductivity sensor 221 will very likely not be equivalent to the desired, final conductivity of the diluted solution. However, because the central controller 236 can monitor the conductivity (and other characteristics) throughout the inline buffer dilution system 200, and because the central controller 236 controls the supply of the diluent through the third flow controller 250 and the amount of diluent has a known effect on conductivity, the central controller 236 can dynamically cause the third flow controller 250 to supply the desired amount of the diluent to meet the target conductivity, based on measurements provided by the sensors. Further, while the pH of a buffer solution is not typically altered by an increase in volume (e.g., due to the addition of the diluent), the central controller 236 provides a feedback mechanism for and controls the release of the first buffer and the second buffer through the flow controllers 205, 210 respectively in order for the final diluted buffer solution to meet a target pH value.

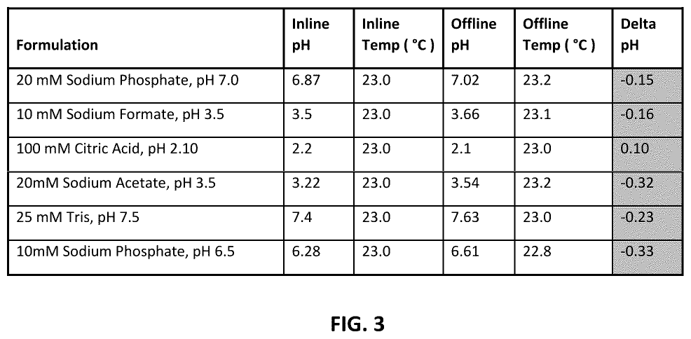

The inventors performed several experiments (with six different formulations) that confirmed that the inline buffer dilution system 200 more accurately measures the pH of the diluted buffer solution than known inline buffer dilution systems such as the inline buffer dilution system 100. Indeed, as shown in FIG. 3, measuring data such as the pH collected by the pH sensor 221, prior to diluting the buffer solution with diluent, leads to the measured pH value being more accurate (i.e., being drastically closer to the actual pH of the diluted buffer solution). The table of FIG. 3 includes the pH value measured inline by the pH sensor 221 and the pH value measured offline (which tends to be very accurate and very closely matches the actual pH), after dilution, and shows that the delta pH between the inline pH and the offline pH is in the range of tenths (which is generally considered to be normal, or within tolerance). For example, the maximum difference shown is 0.33. Because it will be appreciated that slight deviations in pH, on the orders of tenths, can be detrimental, particularly for chemical and biological applications, it is important that the pH value measured inline be as close to the actual pH as possible which should be as close to the desired pH as possible. Additionally, the table of FIG. 3 also includes the inline and offline temperatures for the six different formulations and shows very little difference between the values.

It will also be appreciated that the inline buffer dilution system 200 can include additional flow controllers and/or flow control valves which are in turn adapted to fluidly communicate with additional vessels of buffers (e.g., a fourth vessel containing a supply of a third buffer and a fifth vessel containing a supply of a fourth buffer). As an example, if the inline buffer dilution system 200 includes the flow controllers 240, 245 as well as a fourth and a fifth vessel the inline buffer dilution system 200 can include a fifth flowmeter arranged between the fourth vessel and the corresponding flow controller, and a sixth flowmeter arranged between the fifth vessel and the corresponding flow controller. In other examples, the flowmeters can be positioned after (i.e., downstream of) the corresponding flow controllers in the inline buffer dilution system 200.

Optionally, and as illustrated in FIG. 2, the inline buffer dilution system 200 may include a bubble trap 219 configured to remove gas bubbles from the buffer solution output by the first mixer 215. In this example, the bubble trap 219 is arranged between the first mixer 215 and the conductivity and pH sensors 221, 222, such that the bubble trap 219 is configured to remove gas bubbles from the buffer solution after exiting the first mixer 215 and prior to any data being obtained about the buffer solution by the conductivity and pH sensors 221, 222. In other examples, the bubble trap 219 can be positioned elsewhere in the inline buffer dilution system 200. For example, the bubble trap 219 can be positioned downstream of the conductivity and pH sensors 221, 222 and upstream of the backpressure control valve 260. However, because the usage of a bubble trap such as the bubble trap 219 may increase the time lag for sensor readings, the inline buffer dilution system 200 may alternatively not include a bubble trap.

Optionally, the inline buffer dilution system 200 may include any number of additional components not explicitly illustrated in FIG. 2. In some examples (e.g., when the one or more desired characteristics include a desired temperature), the inline buffer dilution system 200 may include a heat exchanger instead of, or in addition to, the bubble trap 219. In turn, the heat exchanger would be arranged between the first mixer 215 and the conductivity and pH sensors 221, 222, so as to help ensure that the buffer solution output by the first mixer 215 has the desired temperature. In some examples (e.g., when the inline buffer dilution system 200 includes the fourth vessel), the inline buffer dilution system 200 may include a heat exchanger, a pump, a sensor (e.g., a pressure sensor, a bubble sensor, etc.), a pressure regulator, or other component arranged between the fourth vessel and the corresponding flowmeter. In some examples, the inline buffer dilution system 200 may include a sensor (e.g., a temperature sensor, a density sensor, an optical sensor, etc.) arranged between the conductivity and pH sensors 221, 222 and the fourth flowmeter 254.

Finally, it will be appreciated that the above-described components of the inline buffer dilution system 200 are connected together using conduit extending therebetween. Further, it will be appreciated that the above-described components of the inline buffer dilution system 200 may be made from one or more different materials. As discussed above, the first vessel 205 of the first buffer and the second vessel 210 of the second buffer can, for example, each take the form of a container made of a disposable material. Other components of the inline buffer dilution system 200, e.g., the first, second, and third flow controllers 240, 245, and 250, the first mixer 215, and the conduit connecting the various components of the system 200, are also preferably made from a single-use or disposable material, such as a plastic material or polymer material or film material like gamma stable plastic (which can withstand gamma radiation). However, in some examples, the conduit and/or other components of the inline buffer dilution system 200 may instead be made from a metal material (e.g., stainless steel).

Those skilled in the art will recognize that a wide variety of modifications, alterations, and combinations can be made with respect to the above-described embodiments without departing from the scope of the disclosure, and that such modifications, alterations, and combinations are to be viewed as being within the ambit of the inventive concept.

1. An inline buffer dilution system, comprising:
a first flow controller adapted to communicate with a vessel comprising a supply of a first buffer;
a second flow controller adapted to communicate with a vessel comprising a supply of a second buffer;
a first mixer fluidly connected to the first and second flow control mechanism and configured to receive an amount of first buffer fluid via the first flow controller and second buffer fluid via the second flow controller, the first mixer further configured to mix the amount of the first buffer fluid and the second buffer fluid to produce a buffer solution;
a series of sensors fluidly connected to the first mixer and configured to receive the buffer solution from the first mixer, the sensors configured to measure characteristics of the buffer solution;
a third flow controller adapted to communicate with a vessel comprising a supply of a diluent fluid, the third flow controller being arranged downstream of the series of sensors;
a second mixer fluidly connected to the series of sensors and the third flow controller, the second mixer configured to receive the buffer solution via the series of sensors and an amount of diluent fluid via the third flow controller, the second mixer further configured to mix the buffer solution and the amount of diluent fluid to produce a diluted buffer solution; and
a central controller communicatively connected to the series of sensors and the first, second, and third flow controllers, the central controller configured to control the flows of the first buffer through the first flow controller, the second buffer through the second flow controller, and the diluent liquid through the third flow controller.

2. The inline buffer dilution system of claim 1, wherein the series of sensors comprises a pH sensor configured to measure the pH of the buffer solution produced by the first mixer.

3. The inline buffer dilution system of claim 1, wherein the series of sensors comprises a conductivity sensor configured to measure the conductivity of the buffer solution produced by the first mixer.

4. The inline buffer dilution system of claim 3, wherein the central controller is further configured to determine, based on the conductivity of the buffer solution measured by the conductivity sensor, the amount of the diluent fluid to be supplied to the second mixer via the third controller.

5. The inline buffer dilution system of claim 1, further comprising a first flowmeter fluidly coupled to the first flow controller, a second flowmeter fluidly coupled to the second flow controller, and a third flowmeter fluidly coupled to the third flow controller, the central controller communicatively connected to the first, second, and third flowmeters and configured to obtain from the first, second and third flowmeters data indicative of the fluid flowing through the first, second, and third flow controllers, respectively.

6. The inline buffer dilution system of claim 1, wherein the first buffer comprises an acid, and the second buffer comprises a salt.

7. The inline buffer dilution system of claim 1, wherein the second mixer comprises an impeller configured to mix the buffer solution and the amount of diluent fluid.

8. The inline buffer dilution system of claim 1, wherein the first mixer and/or the second mixer is a shear blender.

9. The inline buffer dilution system of claim 1, further comprising a first pressure sensor disposed upstream of the first mixer and configured to measure a pressure of the buffer solution.

10. A method of producing a diluted buffer solution, comprising:
providing a first flow controller adapted to communicate with a first vessel comprising a supply of a first buffer, a second flow controller adapted to communicate with a second vessel comprising a supply of a second buffer, and a third flow controller adapted to communicate with a third vessel comprising a supply of a diluent fluid;
directing an amount of the first buffer and the second buffer to a first mixer via the first and second flow controllers, respectively;
mixing the amount of the first buffer and the second buffer in the first mixer, thereby producing a buffer solution;
measuring characteristics of the buffer solution using a series of sensors;
directing the buffer solution and an amount of the diluent fluid, via the third flow controller, into a second mixer;
mixing the buffer solution and the amount of the diluent fluid in the second mixer to produce a diluted buffer solution; and
controlling, via a central controller communicatively connected to the series of sensors, the flows of the first buffer through the first flow controller, the second buffer through the second flow controller, and the diluent liquid through the third flow controller.

11. The method of claim 10, further comprising measuring the pH of the buffer solution produced by the first mixer using the series of sensors, wherein the series of sensors comprises a pH sensor.

12. The method of claim 10, further comprising measuring the conductivity of the buffer solution produced by the first mixer using the series of sensors, wherein the series of sensors comprises a conductivity sensor.

13. The method of claim 12, further comprising the determining, with the central controller, based on the conductivity of the buffer solution measured by the conductivity sensor, the amount of the diluent fluid to be supplied to the second mixer via the third flow controller.

14. The method of claim 10, wherein the first buffer comprises an acid, and the second buffer comprises a salt.

15. The method of claim 10, wherein the second mixer comprises an impeller configured to mix the buffer solution and the amount of the diluent fluid.

16. A feedback system for inline buffer dilution, comprising:
a flow inlet configured to receive flow of a buffer solution, the buffer solution comprising a mixture of a first buffer released via a first flow controller, and a second buffer released via a second flow controller;
a series of sensors configured to receive the flow of the buffer solution and to measure characteristics of the buffer solution;
a flow outlet fluidly connected to the series of sensors, the flow outlet configured to receive the flow of the buffer solution from the series of sensors;
a third flow controller adapted to communicate with a vessel comprising a supply of a diluent fluid;
a mixer fluidly connected to the flow outlet and the third flow control valve; and
a central controller communicatively connected to the series of sensors, the third flow controller, and the mixer, the central controller configured to obtain the measured characteristics from the series of sensors, the central controller configured to determine an amount of the diluent fluid to be directed to the mixer based on the measured characteristics and target characteristics, the central controller configured to cause the third flow controller to release the determined amount of the diluent fluid to the mixer, and the central controller configured to cause the mixer to mix the buffer solution and the released amount of the diluent fluid, thereby producing a diluted buffer solution.

17. The feedback system of claim 16, further comprising a first flowmeter fluidly coupled to the first flow controller, a second flowmeter fluidly coupled to the second flow controller, and a third flowmeter fluidly coupled to the third flow controller, the central controller communicatively connected to the first, second, and third flowmeters and configured to obtain from the first, second and third flowmeters data indicative of the fluid flowing through the first, second, and third flow controllers, respectively.

18. The feedback system of claim 16, wherein the series of sensors comprises a conductivity sensor configured to measure the conductivity of the buffer solution.

19. The feedback system of claim 18, wherein the central controller is configured to cause the amount of diluent fluid to be released through the third flow controller based on the conductivity of the buffer solution measured by the conductivity sensor.

20. The feedback system of claim 16, wherein the series of sensors comprises a pH sensor configured to measure the pH of the buffer solution.

21. The feedback system of claim 16, wherein the first buffer comprises an acid, and the second buffer comprises a salt.

22. The feedback system of claim 16, wherein the mixer comprises an impeller configured to mix the buffer solution and the released amount of the diluent fluid.
